(19) United States
(12) Patent Application Publication
(10) Pub. No.: US 2023/0160747 A1
(43) Pub. Date: May 25, 2023

(54) CONTROL PULSE DETERMINATION OF QUANTUM GATE

(71) Applicant: BEIJING BAIDU NETCOM SCIENCE TECHNOLOGY CO., LTD., Beijing (CN)

(72) Inventors: Jingbo WANG, Beijing (CN); Yucheng DUAN, Beijing (CN)

(73) Assignee: BEIJING BAIDU NETCOM SCIENCE TECHNOLOGY CO., LTD., Beijing (CN)

(21) Appl. No.: 18/094,967

(22) Filed: Jan. 9, 2023

(30) Foreign Application Priority Data
Jan. 10, 2022 (CN) 202210023296.3

(51) Int. Cl. G01J 3/44; G06N 10/40

(52) U.S. Cl. CPC G01J 3/44; G06N 10/40

(57) ABSTRACT

A method is provided. The method includes: obtaining a frequency of each phonon in an ion trap chip for implementing the quantum gate; determining a frequency of Raman light detuning corresponding to the control pulse and a frequency of a first phonon, where the first phonon is a phonon with a frequency in the ion trap chip closest to the frequency of Raman light detuning; initializing a first pulse sequence and determining a second pulse sequence based on the first pulse sequence, such that the first phonon is decoupled from an ion after the first pulse sequence and the second pulse sequence are successively applied to the ion trap chip; determining an objective function based on a distortion function corresponding to a quantum gate to be implemented; and adjusting an amplitude and a phase of the first pulse sequence and determining the second pulse sequence to minimize the objective function.

### CROSS REFERENCE TO RELATED APPLICATIONS

The present application claims priority to Chinese Patent Application No. 202210023296.3 filed on Jan. 10, 2022, the contents of which is hereby incorporated by reference in its entirety for all purposes.

### TECHNICAL FIELD

The present disclosure relates to the field of computers, in particular to the technical field of quantum computers, and specifically to a method and an apparatus for determining a control pulse of a quantum gate, an electronic device, a computer-readable storage medium, and a computer program product.

### BACKGROUND

In recent years, quantum computers have become increasingly powerful, and an ion trap platform has greatly developed. At present, as hardware platforms thrive, how to effectively perform comprehensive and high-precision pulse control of different hardware provided by different manufacturers is an important direction for future ion trap quantum computing.

### SUMMARY

The present disclosure provides a method and an apparatus for determining a control pulse of a quantum gate, an electronic device, a computer-readable storage medium, and a computer program product.

According to one aspect of the present disclosure, there is provided a method for determining a control pulse of a quantum gate, the method including: obtaining a frequency of each phonon in an ion trap chip for implementing the quantum gate; determining a frequency of Raman light detuning corresponding to the control pulse and a frequency of a first phonon, where the first phonon is a phonon with a frequency in the ion trap chip closest to the frequency of Raman light detuning; initializing a first pulse sequence and determining a second pulse sequence based on the first pulse sequence, such that the first phonon is decoupled from an ion after the first pulse sequence and the second pulse sequence are successively applied to the ion trap chip; determining an objective function based on a distortion function corresponding to a quantum gate; and adjusting an amplitude and a phase of the first pulse sequence and determining the second pulse sequence to minimize the objective function.

According to another aspect of the present disclosure, there is provided an electronic device, including: a memory storing one or more programs configured to be executed by one or more processors, the one or more programs including instructions for causing the electronic device to perform operations comprising: obtaining a frequency of each phonon in an ion trap chip for implementing the quantum gate; determining a frequency of Raman light detuning corresponding to the control pulse and a frequency of a first phonon, wherein the first phonon is a phonon with a frequency in the ion trap chip closest to the frequency of Raman light detuning; initializing a first pulse sequence and determining a second pulse sequence based on the first pulse sequence, such that the first phonon is decoupled from an ion after the first pulse sequence and the second pulse sequence are successively applied to the ion trap chip; determining an objective function based on a distortion function corresponding to the quantum gate; and adjusting an amplitude and a phase of the first pulse sequence and determining the second pulse sequence to minimize the objective function.

According to another aspect of the present disclosure, there is provided a non-transitory computer-readable storage medium that stores one or more programs comprising instructions that, when executed by one or more processors of a computing device, cause the computing device to implement operations comprising: obtaining a frequency of each phonon in an ion trap chip for implementing a quantum gate; determining a frequency of Raman light detuning corresponding to the control pulse and a frequency of a first phonon, wherein the first phonon is a phonon with a frequency in the ion trap chip closest to the frequency of Raman light detuning; initializing a first pulse sequence and determining a second pulse sequence based on the first pulse sequence, such that the first phonon is decoupled from an ion after the first pulse sequence and the second pulse sequence are successively applied to the ion trap chip; determining an objective function based on a distortion function corresponding to the quantum gate; and adjusting an amplitude and a phase of the first pulse sequence and determining the second pulse sequence to minimize the objective function.

It should be understood that the content described in this section is not intended to identify critical or important features of the embodiments of the present disclosure, and is not used to limit the scope of the present disclosure either. Other features of the present disclosure will be easily understood through the following description.

### BRIEF DESCRIPTION OF THE DRAWINGS

The accompanying drawings show embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a flowchart of a method for determining a control pulse of a quantum gate according to an embodiment of the present disclosure;

FIG. 2 is a flowchart of determining an applicable range of noise of a quantum gate according to an embodiment of the present disclosure;

FIG. 3 is a flowchart of a method for determining a control pulse according to an exemplary embodiment of the present disclosure;

FIGS. 4A and 4B are respectively curve diagrams of distortion of a quantum gate obtained according to an existing method and a method according to an embodiment of the present disclosure under a set of parameters;

FIG. 5 is a schematic diagram of a trajectory of a phase space of an ion-phonon coupling strength according to an embodiment of the present disclosure;

FIGS. 6A and 6B are respectively curve diagrams of distortion of a quantum gate obtained according to an existing method and a method according to an embodiment of the present disclosure under another set of parameters;

FIG. 7 is a structural block diagram of an apparatus for determining a control pulse of a quantum gate according to an embodiment of the present disclosure; and

FIG. 8 is a structural block diagram of an exemplary electronic device that can be used to implement an embodiment of the present disclosure.

### DETAILED DESCRIPTION OF EMBODIMENTS

Exemplary embodiments of the present disclosure are described below with reference to the accompanying drawings, where various details of the embodiments of the present disclosure are included for a better understanding, and should be considered as merely exemplary. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

So far, various types of computers in application all have used classical physics as a theoretical basis for information processing, and have been referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the inevitable disadvantages as follows: 1. most basic limitation from energy consumption in a computation process, in which minimum energy required by a logic element or a storage unit should be several times more than kT to avoid malfunction under thermal fluctuations; 2. information entropy and heating energy consumption; and 3. when a computer chip has a very high routing density, according to the Heisenberg's uncertainty principle, less uncertain electron positions indicate more uncertain momentum. When electrons are no longer confined, a quantum interference effect occurs. Such an effect may even damage the performance of the chip.

Quantum computers are physical devices that follow the properties and laws of quantum mechanics to perform high-speed mathematical and logical computation, and store and process quantum information. Any device that processes and computes quantum information and runs a quantum algorithm is a quantum computer. The quantum computers follow the unique quantum dynamics law (especially quantum interference) to implement a new mode of information processing. For parallel processing of computing problems, the quantum computers have an absolute advantage over classical computers in speed. A transformation of each superposition component performed by the quantum computer is equivalent to a classical computation. All these classical computations are completed simultaneously and superposed based on a specific probability amplitude, and an output result of the quantum computer is provided. Such computing is referred to as quantum parallel computing. Quantum parallel processing greatly improves the efficiency of the quantum computer, so that the quantum computer can complete operations that classical computers cannot complete, for example, factorization of a large natural number. Quantum coherence is essentially utilized in all ultrafast quantum algorithms Therefore, quantum parallel computing with quantum states replacing classical states can achieve an incomparable computation speed and an incomparable information processing function than the classical computers and also save a large amount of computation resources.

A quantum gate operation is a core function of a quantum computer, and the correct implementation of a quantum gate operation is a prerequisite for the correct implementation of all quantum algorithms Universal quantum computing requires a set of complete quantum gates. As a platform for quantum computing demonstration, an ion trap, due to a rich energy level structure and quantum characteristics of a microscopic ion, makes an ion confined in the trap become an ideal qubit, so that a quantum gate operation on the same bit can be implemented. For example, a single-bit quantum gate operation can be implemented by means of a Rabi oscillation process between a 1⁰> state and a |¹> state. Usually, the single-bit quantum gate can be implemented by using a two-photon Raman process, and high fidelity can be achieved. A two-bit quantum gate operation relies on an ion vibrational mode. When ions are arranged in a chain in the trap at a low temperature, vibrations of the ions near an equilibrium position will be coupled to each other into measurable phonons (i.e., a phonon mode, and the number of phonons is equal to the number of ions). Detuned Raman light can couple the |⁰> state and the |¹> state of a single ion to a phonon of the ion chain, and if the detuned Raman light is applied to a plurality of ions in the ion trap at the same time, the plurality of ions can be coupled by means of the phonon, so that the two-bit quantum gate operation can be implemented.

Only the coupling between the ions should be retained after the end of an ideal two-bit quantum gate operation. To eliminate ion-phonon coupling, the two-bit quantum gate operation may be implemented by means of pulse slicing. In the current experiments, an ultra-narrow linewidth of a quantum dot laser is at a KHz level, while a frequency stabilization method such as saturated absorption can only make a laser frequency accurate to sub-MHz. The fidelity of a quantum gate generated by means of a pulse slicing solution will be greatly reduced when a frequency of Raman light is drifted and a gate time is distorted; and an optimization solution time is very long when the number of ions increases, which severely limits practicality.

To solve these problems, a pulse phase regulation solution is proposed. A pulse of Raman light is sliced into pulse sequences, and a phase relationship between the pulse sequences is adjusted, so that the ion-phonon coupling can return to an origin of a phase space after one gate time. The change of a coupling strength αᵢⱼ between a phonon i and an ion j is related to a Raman light strength Ω, a Raman light phase ϕ, and a frequency difference (ωᵢ−ωⱼ) between the Raman light and the corresponding phonon. For a pulse sequence [Ω₀, Ω₁, . . . , Ωₙ], [ϕ₀, ϕ₁, . . . , ϕₙ] that is applied to the ion j and has a total time of τ, the coupling strength of the phonon i and the ion j changes from 0 to αᵢⱼ after the action ends. After the action of the pulse sequence, if a phase of the laser is transformed, δᵢ=−π+(ωᵢ−ωⱼ)^{τ} is added to all the phases of the pulse sequence, and then the transformed pulse sequence [Ω₀, Ω₁, . . . , Ωₙ], [ϕ₀, δᵢ, ϕ₁+δᵢ, . . . , ϕₙ+δᵢ] is applied to the ion j, after the action of the pulse ends, the coupling strength of the phonon i and the ion j changes from αᵢⱼ to 0. This is a method for decoupling the phonon i and the ion j using a compensation method. It can be seen that after one phonon is decoupled, the number of slices of the pulse sequence changes from n to 2n. For a system containing N ions, the number of effective phonons is also N. If the N phonons are to be decoupled successively, the number of slices of the pulse sequence becomes 2^{N}n(n*2*2*2), which is the phase regulation method. According to the compensation idea of the method, each phonon-ion coupling strength returns to 0 after the pulse sequence ends, and a compensation equation is still met under a certain range of gate time distortion and a frequency jitter of the Raman light. Therefore, the pulse sequence generated using the method has a very high anti-noise capability. However, such an exponential increase 2^{N} in the number of pulse slices makes the quantum gate time of the ion trap, which is already very long, even more explosively increase, which is unacceptable in experiments. If the total time 2^{N}τ is compressed to be within a proper range, τ will be too short, and the pulse sequence will change too frequently. Current control elements such as lasers and acousto-optic modulators can hardly achieve such a fast operation, and changing a rising edge and falling edge brought by the laser will greatly affect the fidelity.

In addition, Q-CTRL proposed a method for generating an ion trap pulse slice featuring an anti-environmental noise interference capability. By optimizing an objective function of the pulse sequence [Ω₀, Ω₁, . . . , Ωₙ], [ϕ₀, ϕ₁, . . . , ϕₙ], an ion trap pulse control solution featuring an elementary anti-noise capability is achieved. However, an applicable range of the method used by Q-CTRL is very sensitive to experimental parameters, and has strict requirements on a pulse time, detuning selection, etc. As a result, normal optimization cannot be performed under many experimental parameters and diversified experimental platforms are difficult to meet. In addition, in the case of multiple ions, a pulse generated by the method can have a certain anti-interference capability only in the range of noise<KHz level, and the method is not practical for a current laser linewidth and frequency stabilization method.

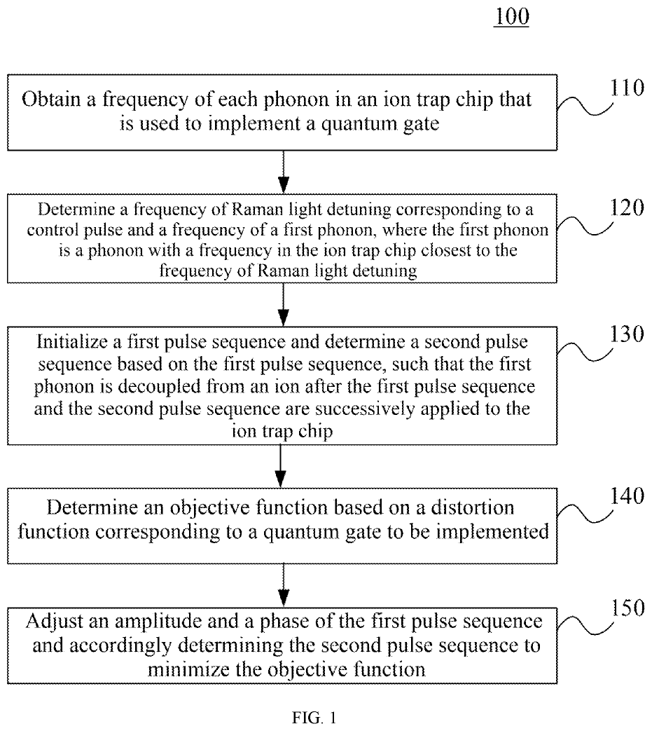

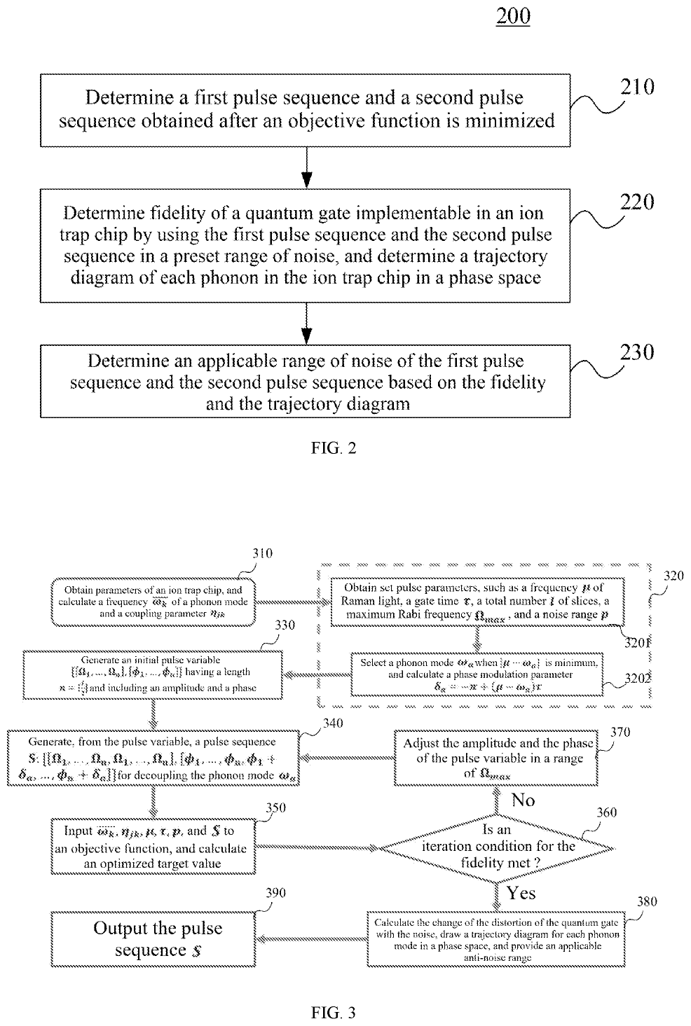

Therefore, according to an embodiment of the present disclosure, there is provided a method for determining a control pulse of a quantum gate, and the method improves the pulse phase regulation solution for the ion trap, thereby making the solution more practical. As shown in FIG. 1, the method 100 for determining a control pulse of a quantum gate includes: obtaining a frequency of each phonon in an ion trap chip that is used to implement the quantum gate (step 110); determining a frequency of Raman light detuning corresponding to the control pulse and a frequency of a first phonon, where the first phonon is a phonon with a frequency in the ion trap chip closest to the frequency of Raman light detuning (step 120); initializing a first pulse sequence and determining a second pulse sequence based on the first pulse sequence, such that the first phonon is decoupled from an ion after the first pulse sequence and the second pulse sequence are successively applied to the ion trap chip (step 130); determining an objective function based on a distortion function corresponding to a quantum gate to be implemented (step 140); and adjusting an amplitude and a phase of the first pulse sequence and accordingly determining the second pulse sequence to minimize the objective function (step 150).

According to the method in this embodiment of the present disclosure, attention is paid only to a phonon with the strongest action with the ion, such that decoupling is implemented after the action of a pulse sequence with the number of slices increasing linearly with the number of qubits, and then the pulse sequence is optimized, so that the remaining phonon-ion coupling strength is reduced to an acceptable range after a gate time ends, so as to obtain a quantum gate having high fidelity.

In some exemplary embodiments, basic parameters, such as a trap frequency ωₓ, ω_{z}, a number N of ions, and mass m of an ion, of the ion trap chip may be obtained in advance. An equilibrium position of an ion in the ion trap, a frequency ω̅ₖ̅ (a vector including N numerical values) of a phonon of an ion chain, a Lamb-Dicke coupling parameter ηⱼₖ (representing a Lamb-Dicke coupling parameter of a j ion and a k phonon), etc. may be further determined based on these basic parameters. During a simulation operation according to the method of the present disclosure, the parameters of the ion trap chip may be input by a user in a customized manner In addition, desired pulse parameters to be set, such as the frequency μ of Raman light detuning, a quantum gate time τ, a desired total number l of pulse slices, and an achievable maximum Rabi frequency Ωₘₐₓ, may also be obtained in advance.

Based on the obtained basic parameters of the ion trap chip and the obtained pulse parameters, a frequency of each phonon in the ion trap chip and a phonon (the first phonon) with the frequency thereof closest to the frequency of Raman light detuning may be determined, that is, a frequency ωₐ of a phonon when |μ−ωₖ| (k=1, . . . , N) is minimum is determined. Considering that the selected frequency of Raman light detuning is usually close to a frequency ω_{α} of a specific phonon, and the phonon has the strongest coupling with an ion, contributing most to the phonon-ion coupling strength. Therefore, attention is paid only to the phonon with the strongest coupling, and compensation decoupling is implemented after the pulse sequence is applied to the phonon, which greatly reduces the number of slices in the pulse sequence.

According to some embodiments, in the process of initializing, adjusting, and optimizing the first pulse sequence, an amplitude of each pulse slice in the first pulse sequence may be set not to exceed the maximum Rabi frequency Ωₘₐₓ of Raman light.

According to some embodiments, the method further includes: determining a total number of preset pulse slices, so as to determine, based on the total number of the pulse slices, a first number of pulse slices in the first pulse sequence and a second number of pulse slices in the second pulse sequence.

In some embodiments, the desired total number l (l being a positive integer) of pulse slices may be determined in advance. Based on the determined total number l of pulse slices, the first number of pulse slices in the first pulse sequence and the second number of pulse slices in the second pulse sequence are separately determined. A sum of the first number of pulse slices and the second number of pulse slices is equal to the total number l of the pulse slices.

According to some embodiments, when the total number l of the pulse slices is an odd number, the first number of pulse slices may be greater than the second number of pulse slices by 1; and when the total number l of the pulse slices is an even number, the first number of pulse slices may be equal to the second number of pulse slices.

For example, based on the preset total number l of the pulse slices, an initial pulse variable [[Ω₁, . . . , Ωₙ], [ϕ₁, . . . , ϕₙ]] having a length

$$n = ⌈ \frac{l}{2} ⌉$$

is generated and used as the first pulse sequence, where Ω represents an amplitude, and represents ϕ phase. Then, (l−n) is the number of pulse slices in the second pulse sequence.

In some examples, the first number of pulse slices and the second number of pulse slices may also be determined based on the total number l of pulse slices in another manner For example, when l is an even number, the first number of pulse slices is greater than the second number of pulse slices by 2, and when l is an odd number, the number of first pulse slice is greater than the second number of pulse slices by 3, and so on, which is not limited herein.

When the first number of pulse slices and the second number of pulse slices are not equal (i.e., the first number of pulse slices is greater than the second number of pulse slices), all pulse slices in the second pulse sequence are in a one-to-one correspondence with the first pulse slices of the second number of pulse slices in the first pulse sequence.

According to some embodiments, an amplitude of each of the pulse slices in the second pulse sequence is the same as that of the each corresponding pulse slice in the second number of the pulse slices among the pulse slices in the first pulse sequence, and a phase of each of the pulse slices in the second pulse sequence differs by a preset constant from the phase of the each corresponding pulse slice in the second number of the pulse slices among the pulse slices in the first pulse sequence. The preset constant may be determined based on the following formula:

δ_{α}=−π+(ω_{α}−μ)τ/2

where ω_{α} is the frequency of the first phonon, μ is the frequency of Raman light detuning, and τ is a gate time of the quantum gate to be implemented.

For example, the preset constant may be added to the phase of the corresponding pulse in the first pulse sequence to obtain the second pulse sequence. For the first pulse sequence [[Ω₁, . . . , Ωₙ], [ϕ₁, . . . , ϕₙ]] obtained during initialization, if the number of pulse slices in the first pulse sequence is equal to the number of pulse slices in the second pulse sequence, the second pulse sequence may be [[Ω₁, . . . , Ωₙ], [ϕ₁+δ_{α}, . . . , ϕₙαδ_{α}]]; and if the number of pulse slices in the first pulse sequence is greater than the number of pulse slices in the second pulse sequence by 1, the second pulse sequence may be [[Ω₁, . . . , Ωₙ, Ω₁, . . . , Ωₙ₋₁], [ϕ₁+δ_{α}, . . . , ϕₙ₋₁+δ_{α}]]. The first pulse sequence and the second pulse sequence are successively applied to a specified ion in the ion trap.

According to some embodiments, an amplitude of each of pulse slices in the first pulse sequence may be initialized based on the following formula:

$${Ω}_{initial} = \sqrt{\frac{μ - {ω}_{a}}{τ {η}_{ja} {η}_{i a}}}$$

where τ is a preset gate time of the quantum gate, μ is the frequency of Raman light detuning, ω_{α} is a frequency of a phonon a closest to the frequency of Raman light detuning, η_{jα} represents a Lamb-Dicke coupling parameter of an ion j and the phonon α, and η_{jα} represents a Lamb-Dicke coupling parameter of an ion i and the phonon α, where the ions i and j are ions selected in the ion trap to generate the quantum gate. In this way, the subsequent optimization is facilitated by scientifically setting an initial value of an amplitude of a pulse sequence.

According to some embodiments, a phase of each of pulse slices in the first pulse sequence may be initialized such that the phase is equal to a first positive number and a first negative number that appear alternately. An absolute value of the first positive number and an absolute value of the first negative number are the same. To be specific, the phase of the first pulse sequence may be initialized to repeatedly flip, such as 1, −1, 1, −1, . . . . It is found in the experiments that initializing the phase of the first pulse sequence to a positive value and a negative value that have the same absolute value and appear alternately, in most cases, compared with a randomly initialized pulse sequence, is better to the effect of a process after the subsequent optimization.

Certainly, it can be understood that the first pulse sequence may also be initialized in another manner, such as random initialization, which is not limited herein.

According to some embodiments, the method according to the present disclosure may further include: determining a preset range p of noise resistible by the quantum gate, so as to determine a corresponding distortion function based on the noise range, and further determine an objective function. In this way, the pulse sequence is optimized in the preset range of noise such that the pulse sequence has a certain anti-noise capability, and the number of pulse slices is limited to the linear increase level, greatly increasing the practicability of the method according to the present disclosure.

According to the method in this embodiment of the present disclosure, under most parameters of the ion trap, a high-fidelity control pulse sequence of the quantum gate of the ion trap can be obtained only with the number of laser pulse slices linearly increasing with the number of qubits, and high fidelity can still be maintained under the action of noise such as Raman light frequency drifting and gate time drifting.

According to some embodiments, the method according to the present disclosure may further include the step 200 of determining an applicable range of noise of the quantum gate. The step 200 may include: determining the first pulse sequence and the second pulse sequence obtained after the objective function is minimized (step 210); determining fidelity of the quantum gate implementable in the ion trap chip by using the first pulse sequence and the second pulse sequence in the preset range of noise, and determining a trajectory diagram of each phonon in the ion trap chip in a phase space (step 220); and determining an applicable range of noise of the first pulse sequence and the second pulse sequence based on the fidelity and the trajectory diagram (step 230). The applicable anti-noise range of the quantum gate can be provided by performing noise processing on the optimized pulse sequence in the preset range of noise, observing the change of the fidelity of the quantum gate thereof with noise, and drawing the trajectory diagram of each phonon in the phase space.

FIG. 3 is a flowchart of a method for determining a control pulse according to an exemplary embodiment of the present disclosure. As shown in FIG. 3, in step 310, basic parameters, such as a trap frequency ωₓ, ω_{z}, a number N of ions, and mass m of an ion, of an ion trap chip may be first obtained, and an equilibrium position of an ion in the ion trap, a frequency ω̅ₖ̅ of a phonon of an ion chain, and a Lamb-Dicke coupling parameter ηⱼₖ are determined based on these basic parameters. In step 320, desired pulse parameters to be set experimentally are obtained. For example, a frequency μ of Raman light detuning, a gate time τ, a desired total number l of pulse slices (here, l is directly set to an even number for the convenience of description), an achievable maximum Rabi frequency Ωₘₐₓ, an anti-noise range p, an acting ion i,j, etc. are obtained (step 3201). In addition, based on the parameters obtained above, a frequency ω_{α} of a phonon when |μ−ω_{α}| is minimum is determined, and a phase modulation parameter δ_{α}=−π+(ω_{α}−μ)π/2 is calculated (step 3202). In step 330, an initial pulse variable [[Ω₁, . . . , Ωₙ], [ϕ₁, . . . , ϕₙ]] having a length

$$n = ⌈ \frac{l}{2} ⌉$$

(because l is an even number, n=l/2) is generated based on the known ion trap and pulse setting parameters, and each amplitude and phase parameter of the initialized pulse sequence are free variables. In other words, Ω₀, Ω₁, . . . , Ωₙ and ϕ₀, ϕ₁, . . . , ϕₙ are both free variables, and a free variable needs to be subsequently adjusted and optimized based on an objective function. An initial value of the free variable may be set to be related to the gate time, the frequency of a phonon, the frequency of Raman light detuning, the ion i,j and a Lamb-Dicke coupling parameter η_{jα}, η_{iα} of a phonon having a frequency ω_{α}, so as to facilitate subsequent optimization.

In step 340, an initial pulse sequence [[Ω₁, . . . , Ωₙ, Ω₁, . . . , Ωₙ], [ϕ₁, . . . , ϕₙ, ϕ₁+δ_{α}, . . . , ϕₙαδ_{α}]] that meets compensation decoupling for the phonon ω_{α} is generated from the pulse variable, a total number of pulse slices in the pulse sequence is l, and the pulse sequence includes n free variables and is set to: S=[[Ω₁, . . . , Ω₁], [ϕ₁, . . . , ϕ₁]]. In step 350, the pulse sequence S, the anti-noise range p, etc. are input to the objective function, and an objective value f is calculated as a distortion of the quantum gate. ƒ=ƒ₀+ƒ₊+ƒ₋, a term that does not include noise is ƒ₀=g(μ, ω̅ₖ̅, ηⱼₖ, τ, S), and terms that include noise are ƒ₊=g(μ+p, ω̅ₖ̅, ηⱼₖ, τ, S). and ƒ₋=g(μ−p, ω̅ₖ̅, ηⱼₖ, τ, S). g(μ, ω̅ₖ̅, ηⱼₖ, τ, S) is a first-order Taylor expansion of a distortion function for the ion-phonon coupling strength α. For example, for a two-bit gate operation with a target coupling strength of ϕ (the target coupling strength may be determined based on a quantum gate to be implemented, for example, when the quantum gate to be implemented is a maximum entanglement gate, the target coupling strength is

$$ϕ = \frac{π}{4 )} ,$$

a complete function expression for the fidelity is provided:

$$F = \frac{1}{8} [ 2 cos ( ϕ - {χ}_{i j} ) ( {e}^{- {Σ}_{k = 1}^{N} \frac{\vert {α}_{i , k} ( τ ) {\vert}^{2} {β}_{k}}{2}} + {e}^{- {Σ}_{k = 1}^{N} \frac{\vert {α}_{j , k} ( τ ) {\vert}^{2} {β}_{k}}{2}} ) + ( {{e}^{- {Σ}_{k = 1}^{N}}}^{{{\frac{\vert {α}_{i , k} ( τ ) + {α}_{j , k} ( τ ) {\vert}^{2} {β}_{k}}{2}}^{}}_{}} + {{e}^{- {Σ}_{k = 1}^{N}}}^{{{\frac{\vert {α}_{i , k} ( τ ) - {α}_{j , k} ( τ ) {\vert}^{2} {β}_{k}}{2}}^{}}_{}} ) ]$$

where 1−F is the distortion function. A function expression for χ, α, and β is given below:

$${χ}_{m , n} = {\sum }_{n = 1}^{l} {\sum }_{{n}^{′} = 1}^{l} {Ω}_{n} {{Ω}_{n}}^{′} {\sum }_{k = 1}^{N} {\int }_{( n - 1 ) τ / l}^{n τ / l} d {t}_{2} {\int }_{( {n}^{′} - 1 ) τ / l}^{{n}^{′} τ / l} {dt}_{1} {η}_{m , k} {η}_{n , k} sin {ω}_{k} ( {t}_{2} - {t}_{1} ) sin {μt}_{2} sin μ {t}_{1}$$

$${a}_{m , k} = - {\sum }_{n = 1}^{l} {Ω}_{n} {η}_{m , k} {\int }_{\frac{( n - 1 ) τ}{l}}^{\frac{n τ}{l}} sin ( μt ) {e}^{i {ω}_{k} t} dt$$

$${β}_{k} = coth [ \frac{1}{2} ln ( 1 + \frac{ℏ {ω}_{k}}{{k}_{B} T} ) ]$$

In step 360, whether a corresponding requirement for the fidelity of the quantum gate is met is determined as an iteration condition. If the corresponding requirement for the fidelity of the quantum gate is not met (step 3360, “No”), in step 370, the input free variable [Ω₁, . . . , Ωₙ], [ϕ₁, . . . , ϕₙ] in the pulse sequence is dynamically adjusted based on the distortion of the quantum gate, without exceeding the limit of the maximum Rabi frequency Ωₘₐₓ at the same time. Steps 340 and 350 are repeated until a set optimization termination condition is met. In step 380, noise processing may be performed on the optimized pulse sequence in the set noise range, the change of the fidelity of the quantum gate of the optimized pulse sequence with the noise is observed, a trajectory diagram of each phonon mode in a phase space is made, and an applicable anti-noise range is provided. Therefore, in step 390, the optimized pulse sequence information S is output.

According to the method described in the foregoing embodiment, the practical requirement for pulse regulation can be met, and because the selected initial value of the pulse amplitude is scientific and reasonable during initialization of the pulse sequence, when the selected initial value is used as the initial value in the optimization process, some unreasonable plateaus, local optimal values, etc. of the objective function can be avoided. The optimization method implemented in this embodiment has excellent performance in a fairly wide range of experimental parameters, the generated optimized pulse presents high fidelity in a considerable noise range, and the number of required pulse slices increases linearly as the number of ions increases, thereby enhancing the practicality of the method.

In an exemplary application according to an embodiment of the present disclosure, five ytterbium (Yb) ions are selected for demonstration. In a one-dimensional ion chain with a transversal confinement frequency less than a longitudinal confinement frequency, a first ion and a fifth ion are selected to optimize a

$$\frac{π}{4}$$

Mølmer-Sørense (MS) interaction gate using a phase modulation method. Selecting environmental information of an ion trap and setting pulse parameters are shown in Table 1.

TABLE 1

| Environmental parameters of an ion trap | | Setting pulse parameters | |
|---|---|---|---|
| Number of ions | 5 | Quantum gate time | 1336 μs |
| Ion mass number | 171 | Raman light | 1.446 MHz |
| | | detuning | |
| Transversal harmonic | 0.3 MHz | Number of pulse | 14 |
| frequency | | slices | |
| Longitudinal harmonic | 1.6 MHz | Number of | 18 μm⁻¹ |
| frequency | | equivalent | |
| | | waves of | |
| | | Raman light | |
| Temperature of an ion chain | 0.1 mK | Acting ion | [1, 5] |

Under such a selection of parameters, a pulse sequence generated using an existing method (i.e., a solution in the industry) is compared with a pulse sequence generated using the method (the present solution) according to the embodiment of the present disclosure, and distortions of a

$$\frac{π}{4}$$

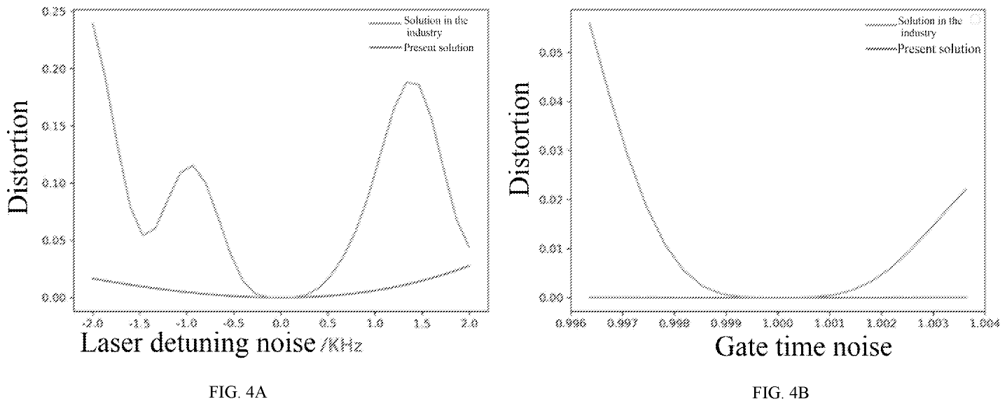

double-quantum gate thereof under detuning noise and gate time noise are shown in FIGS. 4A and 4B, respectively. It can be seen that at the detuning noise of −2.0 KHz and −0.7 KHz, distortions of the quantum gate corresponding to the pulse sequence generated using the method in the embodiment of the present disclosure are 0.017 and 0.02, while distortions of the quantum gate corresponding to the pulse sequence generated using the existing method reach 0.24 and 0.07 at the two points. For the gate time noise, in a gate time fluctuation of 0.996 to 1.004, the distortion of the method in the embodiment of the present disclosure is always maintained below 0.0001, while distortions of the existing method at two ends reach 0.056 and 0.022.

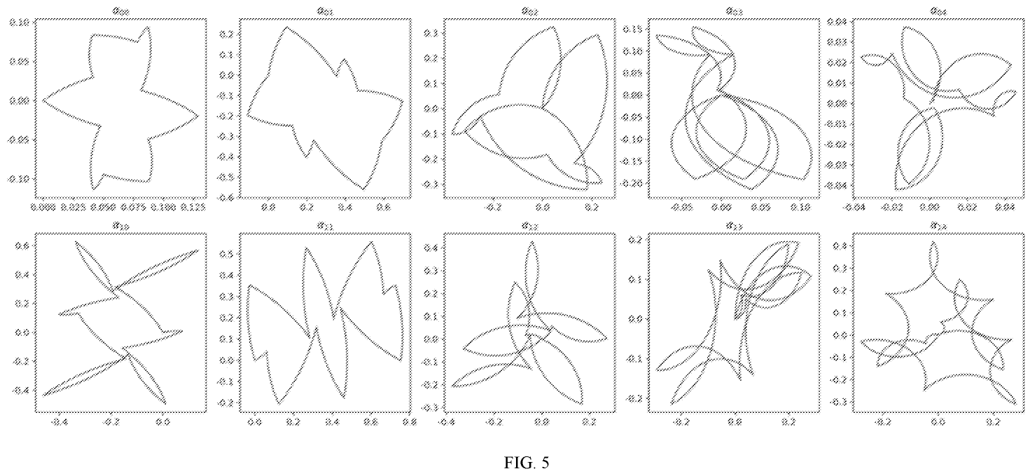

Under the action of a pulse obtained using the method according to the embodiment of the present disclosure, a trajectory diagram of coupling strength of two ions and each phonon in the phase space is shown in FIG. 5. Due to the reasonable selection of an initial variable, the method of the method in the embodiment of the present disclosure can optimize some situations that cannot be optimized by the existing method. For example, based on with parameter settings shown in Table 2, the existing method cannot perform optimization, while the method of the method in this embodiment of the present disclosure still can perform optimization normally:

TABLE 2

| Environmental parameters of an ion trap | | Setting pulse parameters | |
|---|---|---|---|
| Number of ions | 8 | Quantum | 200 μs |
| | | gate time | |
| Ion mass number | 171 | Raman light | 17.11 MHz |
| | | detuning | |
| Transversal harmonic | 3.87 MHz | Number of pulse | 16 |
| frequency | | slices | |
| Longitudinal harmonic | 22.5 MHz | Number of | 24 μm⁻¹ |
| frequency | | equivalent | |
| | | waves of | |
| | | Raman light | |
| Temperature of an ion chain | 0.1 mK | Acting ion | [2, 4] |

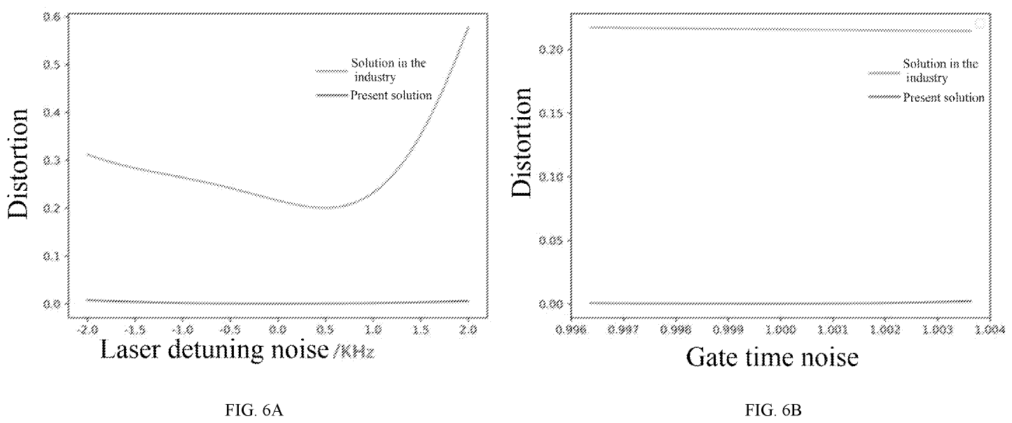

Under such a selection of parameters, a pulse sequence generated using an existing method (i.e., a solution in the industry) is compared with a pulse sequence generated using the method (the present solution) according to the embodiment of the present disclosure, and distortions of a quantum gate thereof under detuning noise and gate time noise are shown in FIGS. 6A and 6B, respectively. It can be seen that the distortion of the pulse sequence provided using the existing method is greater than 0.2 even in the absence of noise. This situation shows that the fidelity of the quantum gate formed using the existing method is less than 0.8, which is far lower than an acceptable fidelity threshold for a quantum computer. Therefore, the existing method does not effectively optimize such parameter setting. In contrast, the method in the embodiment of the present disclosure still maintains a distortion of 0.008 when frequency noise reaches 2 KHz, and maintains a distortion of 0.0007 when a factor of the gate time noise is 1.004.

For the existing phase regulation method, the number of required pulse slices increases exponentially as the number of ions increases. However, the method according to the embodiment of the present disclosure only requires the number of slices that increases linearly with the number of ions to achieve a better result. Table 3 shows a comparison between distortions of pulses generated using the two solutions under noise of 2 KHz in the case of different ion numbers:

TABLE 3

| | | | | |
|---|---|---|---|---|
| Number of ions | 3 | 4 | 6 | 8 |
| Number of slices | 8 | 16 | 64 | 512 |
| of an existing | | | | |
| phase regulation | | | | |
| method | | | | |
| Fidelity of an | 0.00004 | 0.00006 | 0.00001 | 0.00004 |
| existing phase | | | | |
| regulation | | | | |
| method | | | | |
| Number of slices | 6 | 8 | 12 | 16 |
| of the method | | | | |
| of the present | | | | |
| disclosure | | | | |
| Fidelity of the | 0.002 | 0.009 | 0.006 | 0.013 |
| method of the | | | | |
| present | | | | |
| disclosure | | | | |

The selection of parameters is the same as that in Table 1, and an only difference is that the acting ion becomes [1, 2]. It can be seen that although the existing phase modulation method has excellent performance, the minimum number of required slices increases exponentially as the number of ions increases, which cannot be truly implemented on an experimental platform. According to the method of the present disclosure, the number of required slices increases linearly as the number of ions increases, and the fidelity can still be maintained at an acceptable level under the action of noise of 2 KHz.

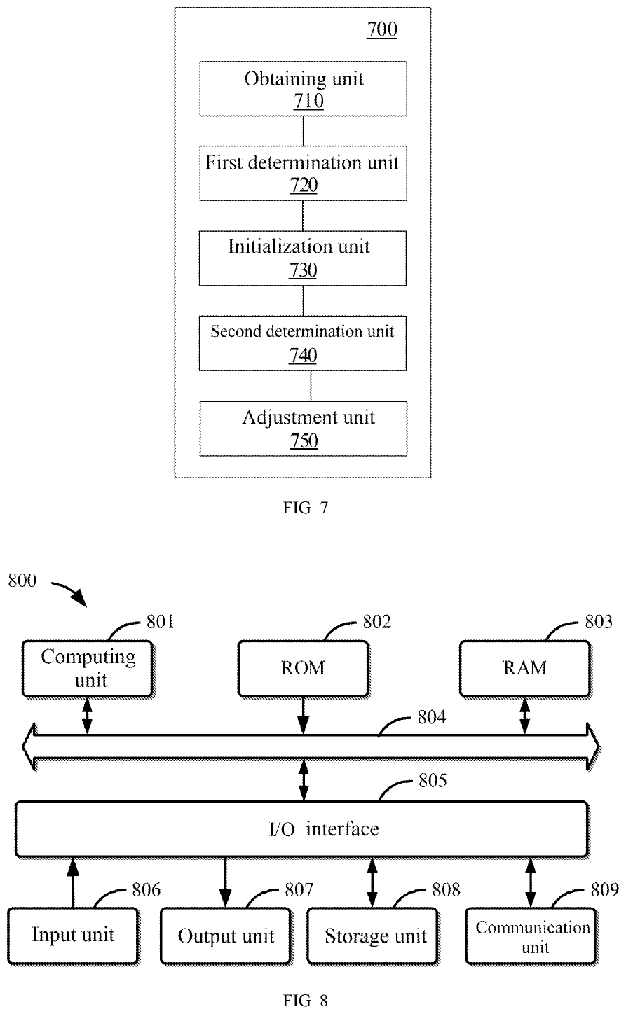

According to an embodiment of the present disclosure, as shown in FIG. 7, there is further provided an apparatus 700 for determining a control pulse of a quantum gate, the apparatus including: an obtaining unit 710 configured to obtain a frequency of each phonon in an ion trap chip that is used to implement the quantum gate; a first determination unit 720 configured to determine a frequency of Raman light detuning corresponding to the control pulse and a frequency of a first phonon, where the first phonon is a phonon with a frequency in the ion trap chip closest to the frequency of Raman light detuning; an initialization unit 730 configured to: initialize a first pulse sequence and determine a second pulse sequence based on the first pulse sequence, such that the first phonon is decoupled from an ion after the first pulse sequence and the second pulse sequence are successively applied to the ion trap chip; a second determination unit 740 configured to determine an objective function based on a distortion function corresponding to a quantum gate to be implemented; and an adjustment unit 750 configured to: adjust an amplitude and a phase of the first pulse sequence and accordingly determine the second pulse sequence to minimize the objective function.

Herein, the operations of the foregoing units 710 to 750 of the apparatus 700 for determining a control pulse of a quantum gate are respectively similar to the operations in steps 110 to 150 described above. Details are not provided herein again.

According to the embodiments of the present disclosure, there are further provided an electronic device, a readable storage medium, and a computer program product.

Referring to FIG. 8, a structural block diagram of an electronic device 800 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 8, the electronic device 800 includes a computing unit 801, which may perform various appropriate actions and processing according to a computer program stored in a read-only memory (ROM) 802 or a computer program loaded from a storage unit 808 to a random access memory (RAM) 803. The RAM 803 may further store various programs and data required for the operation of the electronic device 800. The computing unit 801, the ROM 802, and the RAM 803 are connected to each other through a bus 804. An input/output (I/O) interface 805 is also connected to the bus 804.

A plurality of components in the electronic device 800 are connected to the I/O interface 805, including: an input unit 806, an output unit 807, the storage unit 808, and a communication unit 809. The input unit 806 may be any type of device capable of entering information to the electronic device 800. The input unit 806 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 807 may be any type of device capable of presenting information, and may include, but is not limited to, a display, a speaker, a video/audio output terminal, a vibrator, and/or a printer. The storage unit 808 may include, but is not limited to, a magnetic disk and an optical disc. The communication unit 809 allows the electronic device 800 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, an 802.11 device, a Wi-Fi device, a WiMAX device, a cellular communication device, and/or the like.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 801 performs the various methods and processing described above, for example, the method 100. For example, in some embodiments, the method 100 may be implemented as a computer software program, which is tangibly contained in a machine-readable medium, such as the storage unit 808. In some embodiments, a part or all of the computer program may be loaded and/or installed onto the electronic device 800 via the ROM 802 and/or the communication unit 809. When the computer program is loaded onto the RAM 803 and executed by the computing unit 801, one or more steps of the method 100 described above can be performed. Alternatively, in other embodiments, the computing unit 801 may be configured, by any other suitable means (for example, by means of firmware), to perform the method 100.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: the systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an light fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method, the method comprising:
obtaining a frequency of each phonon in an ion trap chip for implementing a quantum gate;
determining a frequency of Raman light detuning corresponding to a control pulse and a frequency of a first phonon, wherein the first phonon is a phonon with a frequency in the ion trap chip closest to the frequency of Raman light detuning;
initializing a first pulse sequence and determining a second pulse sequence based on the first pulse sequence, such that the first phonon is decoupled from an ion after the first pulse sequence and the second pulse sequence are successively applied to the ion trap chip;
determining an objective function based on a distortion function corresponding to the quantum gate; and
adjusting an amplitude and a phase of the first pulse sequence and determining the second pulse sequence to minimize the objective function.

2. The method according to claim 1, wherein a second number of pulse slices in the second pulse sequence is greater than or equal to a first number of pulse slices in the first pulse sequence, and
an amplitude of each of the pulse slices in the second pulse sequence is the same as an amplitude of each corresponding pulse slice in the second number of pulse slices among the pulse slices in the first pulse sequence; and
a phase of each of the pulse slices in the second pulse sequence differs by a preset constant from the phase of each corresponding pulse slice in the second number of pulse slices among the pulse slices in the first pulse sequence, wherein
the preset constant is determined based on the following formula:
δ_{α}=−π+(ω_{α}−μ)τ/2
wherein ω_{α} is the frequency of the first phonon, μ is the frequency of Raman light detuning, and τ is a gate time of the quantum gate to be implemented.

3. The method according to claim 1, further comprising: determining a total number of preset pulse slices, so as to determine, based on the total number of the pulse slices, the first number of pulse slices in the first pulse sequence and the second number of pulse slices in the second pulse sequence.

4. The method according to claim 3, wherein
when the total number of the pulse slices is an odd number, the first number of pulse slices is greater than the second number of pulse slices by 1; and
when the total number of the pulse slices is an even number, the first number of pulse slices is equal to the second number of pulse slices.

5. The method according to claim 1, wherein the initializing a first pulse sequence comprises:
initializing an amplitude of each of pulse slices in the first pulse sequence based on the following formula:
$${Ω}_{initial} = \sqrt{\frac{μ - {ω}_{a}}{τ {η}_{j a} {η}_{ia}}}$$
wherein τ is a preset gate time of the quantum gate to be implemented, μ is the frequency of Raman light detuning, ω_{α} is a frequency of the first phonon α, η_{jα} represents a Lamb-Dicke coupling parameter of an ion j and the first phonon α, and η_{iα} represents a Lamb-Dicke coupling parameter of an ion i and the first phonon α, wherein the ions i and j are ions selected in an ion trap to generate the quantum gate.

6. The method according to claim 1, wherein the initializing a first pulse sequence comprises:
initializing a phase of each of pulse slices in the first pulse sequence such that the phase is equal to a first positive number and a first negative number that appear alternately, wherein an absolute value of the first positive number and an absolute value of the first negative number are the same.

7. The method according to claim 1, further comprising: determining a preset range of noise resistible by the quantum gate, wherein the determining the objective function based on the distortion function corresponding to the quantum gate to be implemented comprises: determining the distortion function based on the present range of noise and further determining the objective function.

8. The method according to claim 1, wherein an amplitude of each of pulse slices in the first pulse sequence is less than or equal to a maximum Rabi frequency of Raman light.

9. The method according to claim 1, further comprising:
determining the first pulse sequence and the second pulse sequence after the objective function is minimized;
determining a fidelity of the quantum gate implementable in the ion trap chip by using the first pulse sequence and the second pulse sequence in a preset range of noise, and determining a trajectory diagram of each phonon in the ion trap chip in a phase space; and
determining an applicable range of noise of the first pulse sequence and the second pulse sequence based on the fidelity and the trajectory diagram.

10. An electronic device, comprising:
a memory storing one or more programs configured to be executed by one or more processors, the one or more programs including instructions for causing the electronic device to perform operations comprising:
obtaining a frequency of each phonon in an ion trap chip for implementing a quantum gate;
determining a frequency of Raman light detuning corresponding to a control pulse and a frequency of a first phonon, wherein the first phonon is a phonon with a frequency in the ion trap chip closest to the frequency of Raman light detuning;
initializing a first pulse sequence and determining a second pulse sequence based on the first pulse sequence, such that the first phonon is decoupled from an ion after the first pulse sequence and the second pulse sequence are successively applied to the ion trap chip;
determining an objective function based on a distortion function corresponding to the quantum gate; and
adjusting an amplitude and a phase of the first pulse sequence and determining the second pulse sequence to minimize the objective function.

11. The electronic device according to claim 10, wherein a second number of pulse slices in the second pulse sequence is greater than or equal to a first number of pulse slices in the first pulse sequence, and
an amplitude of each of the pulse slices in the second pulse sequence is the same as an amplitude of each corresponding pulse slice in the second number of pulse slices among the pulse slices in the first pulse sequence; and
a phase of each of the pulse slices in the second pulse sequence differs by a preset constant from the phase of each corresponding pulse slice in the second number of pulse slices among the pulse slices in the first pulse sequence, wherein
the preset constant is determined based on the following formula:
δ_{α}=−π+(ω_{α}−μ)π/2
wherein ω_{α} is the frequency of the first phonon, μ is the frequency of Raman light detuning, and τ is a gate time of the quantum gate to be implemented.

12. The electronic device according to claim 10, the operations further comprising:
determining a total number of preset pulse slices, so as to determine, based on the total number of the pulse slices, the first number of pulse slices in the first pulse sequence and the second number of pulse slices in the second pulse sequence.

13. The electronic device according to claim 12, wherein
when the total number of the pulse slices is an odd number, the first number of pulse slices is greater than the second number of pulse slices by 1; and
when the total number of the pulse slices is an even number, the first number of pulse slices is equal to the second number of pulse slices.

14. The electronic device according to claim 10, wherein the initializing a first pulse sequence comprises:
initializing an amplitude of each of pulse slices in the first pulse sequence based on the following formula:
$${Ω}_{initial} = \sqrt{\frac{μ - {ω}_{a}}{τ {η}_{j a} {η}_{i a}}}$$
wherein τ is a preset gate time of the quantum gate to be implemented, μ is the frequency of Raman light detuning, ω_{α} is a frequency of the first phonon α, η_{jα} represents a Lamb-Dicke coupling parameter of an ion j and the first phonon α, and η_{iα} represents a Lamb-Dicke coupling parameter of an ion i and the first phonon α, wherein the ions i and j are ions selected in an ion trap to generate the quantum gate.

15. The electronic device according to claim 10, wherein the initializing a first pulse sequence comprises:
initializing a phase of each of pulse slices in the first pulse sequence such that the phase is equal to a first positive number and a first negative number that appear alternately, wherein an absolute value of the first positive number and an absolute value of the first negative number are the same.

16. The electronic device according to claim 10, the operations further comprising:
determining a preset range of noise resistible by the quantum gate, wherein the determining the objective function based on the distortion function corresponding to the quantum gate to be implemented comprises: determining the distortion function based on the present range of noise and further determining the objective function.

17. The electronic device according to claim 10, wherein an amplitude of each of pulse slices in the first pulse sequence is less than or equal to a maximum Rabi frequency of Raman light.

18. The electronic device according to claim 10, the operations further comprising:
determining the first pulse sequence and the second pulse sequence after the objective function is minimized;
determining a fidelity of the quantum gate implementable in the ion trap chip by using the first pulse sequence and the second pulse sequence in a preset range of noise, and determining a trajectory diagram of each phonon in the ion trap chip in a phase space; and
determining an applicable range of noise of the first pulse sequence and the second pulse sequence based on the fidelity and the trajectory diagram.

19. A non-transitory computer-readable storage medium that stores one or more programs comprising instructions that, when executed by one or more processors of a computing device, cause the computing device to implement operations comprising:
obtaining a frequency of each phonon in an ion trap chip for implementing a quantum gate;
determining a frequency of Raman light detuning corresponding to a control pulse and a frequency of a first phonon, wherein the first phonon is a phonon with a frequency in the ion trap chip closest to the frequency of Raman light detuning;
initializing a first pulse sequence and determining a second pulse sequence based on the first pulse sequence, such that the first phonon is decoupled from an ion after the first pulse sequence and the second pulse sequence are successively applied to the ion trap chip;
determining an objective function based on a distortion function corresponding to the quantum gate; and
adjusting an amplitude and a phase of the first pulse sequence and determining the second pulse sequence to minimize the objective function.

20. The non-transitory computer-readable storage medium according to claim 19,
wherein a second number of pulse slices in the second pulse sequence is greater than or equal to a first number of pulse slices in the first pulse sequence, and
an amplitude of each of the pulse slices in the second pulse sequence is the same as an amplitude of each corresponding pulse slice in the second number of pulse slices among the pulse slices in the first pulse sequence; and
a phase of each of the pulse slices in the second pulse sequence differs by a preset constant from the phase of each corresponding pulse slice in the second number of pulse slices among the pulse slices in the first pulse sequence, wherein
the preset constant is determined based on the following formula:
δ_{α}=−π+(ω_{α}−μ)τ/2
wherein ω_{α} is the frequency of the first phonon, μ is the frequency of Raman light detuning, and τ is a gate time of the quantum gate to be implemented.
